(19) United States
(12) Patent Application Publication
(10) Pub. No.: US 2020/0398246 A1
(43) Pub. Date: Dec. 24, 2020

(54) COMPOSITE MATERIAL AND A METHOD FOR PREPARING THE SAME

(71) Applicant: AGENCY FOR SCIENCE, TECHNOLOGY AND RESEARCH, Singapore (SG)

(72) Inventors: Xu Li, Singapore (SG); Jiating He, Singapore (SG); Chin Chong Yap, Singapore (SG)

(21) Appl. No.: 16/977,592

(22) PCT Filed: Mar. 5, 2019
(86) PCT No.: PCT/SG2019/050122

§ 371 Date: Sep. 2, 2020

(30) Foreign Application Priority Data
Mar. 5, 2018 (SG) 10201801795R

(51) Int. Cl. B01J 20/10; B01J 20/28; A23L 3/3436; B01J 20/30

(52) U.S. Cl. CPC B01J 20/103; B01J 20/28054; A23L 3/3436; B82Y 30/00; B01J 20/28007; B01J 20/3085; B01J 20/28026

(57) ABSTRACT

The present invention generally relates to a composite material. In particular, the present invention relates to a composite material comprising a mixture of a plurality of metal particles and a porous silica particle, wherein said metal particles are disposed within the pores of the porous silica particle. The present invention also provides a method for preparing the composite material used as an oxygen scavenger.

### CROSS-REFERENCE TO RELATED APPLICATION

This application claims priority to Singapore application number 10201801795R filed on 5 Mar. 2018, the disclosure of which is hereby incorporated by reference.

### TECHNICAL FIELD

The present invention generally relates to a composite material. In particular, the present invention relates to a composite material comprising a mixture of a plurality of metal particles and a porous silica particle, wherein said metal particles are disposed within the pores of the porous silica particle.

### BACKGROUND ART

The presence of oxygen in a packaging is one of the determining factors in the quality of the products packaged. Perishable foods such as fruits and vegetables are sensitive to oxygen and thus easy to deteriorate in the presence of oxygen. Such deterioration may result in, among others, dissipation of vitamin C, oxidative rancidity of fats and oils, growth of microorganisms and discoloration. Thus, one of the main objectives of the food packaging is to protect the food packaged from direct contact with oxygen to thereby preserve the nutritional value of food and to prolong the shelf life of the packaged food.

Efforts have been done to provide packaging with good barrier property against permeation of oxygen molecules. Modified atmosphere and vacuum packaging are widely known methods to reduce the oxygen content in the package prior to the sealing process. However, it is noted that the residue oxygen i.e. oxygen dissolved in the food and/or present in the headspace cannot be completely removed by the above methods. Additionally, high cost and complex operations are some of the issues associated with the modified atmosphere and vacuum packaging. Developing an effective oxygen scavenger is therefore highly desirable.

It has been reported that oxygen scavenger accounts for approximately 57% of the plastic packaging market worldwide, noting that oxygen is one of the main contributing factors for food spoilage. Oxygen scavengers generally work based on the oxidation process. The commonly known oxygen scavengers include iron powder, ascorbic acid, enzymes, unsaturated hydrocarbon and photosensitive polymers. However, the above oxygen scavengers have been shown to have some limitations. For instance, organic and unsaturated hydrocarbon scavengers are relatively unstable and tend to emit unwanted (unpleasant) odour following the oxidation process. Among the above oxygen scavengers, Iron-based oxygen scavenger is the most well-known and market available due to its high scavenging efficiency, low cost and non-toxicity.

Iron particles having smaller size tend to exhibit higher scavenging capacity compared to the counterpart of larger particles due to a larger amount of reactive surface atoms. It is therefore expected that nanosized iron particles (or iron nanoparticles) have potential application in oxygen scavenging. However, such relatively small iron particles tend to be active and explosive rendering difficulties in handling such material, in particular during the industry scale of production.

The present invention therefore provides a composite material used as an oxygen scavenger that overcomes, or at least ameliorates, one or more of the disadvantages described above.

### SUMMARY

In one aspect, there is provided a composite material comprising a mixture of a plurality of metal particles and a porous silica particle, wherein said metal particles are disposed within the pores of the porous silica particle.

Advantageously, said silica particle may serve as a carrier for the plurality of metal particles. Nanosized channels formed in the porous silica particle are beneficial as they may serve as a carrier and protector for the growth of metal particles and to thereby enhance the loading of the metal particles without aggregation. Further advantageously, these channels formed may prevent the nanosized metal particles from explosion. Therefore, the resulting nanostructured composite materials are easy to be adopted in industry production.

The channels formed within the porous silica particle may advantageously facilitate the diffusion of oxygen into the silica particle and to thereby improve the contact between metal nanoparticles and oxygen molecules. The channels may also control the oxidation rate of the metal particles.

Still advantageously, the nanostructured composite material may have a relatively large cavity at the center, such relatively large cavity may further improve the contact of oxygen molecules and metal nanoparticles, resulting in high oxygen scavenging capacity. The nanostructured composite material having a large cavity in the center is able to scavenge oxygen efficiently. The hollow in the nanostructured composite material may further facilitate the diffusion of oxygen in the particles and enhance the contact of metal nanoparticles and oxygen, leading to high oxygen scavenging performance.

In another aspect, there is provided a method of preparing a composite material comprising a mixture of a plurality of metal particles and a porous silica particle material for scavenging oxygen, comprising the steps of:

(i) adding the porous silica particle into a solution of metal ions under stirring to allow the metal ions to impregnate into the pores of the silica particle; and

(ii) reducing the metal ions in the presence of a reducing agent to form the metal particles, wherein the metal particles are disposed within the pores of the porous silica particle.

Advantageously, the composite material may be obtained in a facile method via a one-step emulsion preparation method under mild condition. Accordingly, such process may require a simple production setup and therefore may be regarded as low cost process.

Yet advantageously, the size and structure of the porous silica particle may be easily tuned by changing the ratio of precursors. The size of the channel in the composite material may be substantially uniform along the individual channel of the mesoporous silica particle.

In another aspect, there is provided a composition comprising the composite material as defined herein and a polymeric matrix, wherein said metal particles are disposed within the pores of the porous silica particle.

In another aspect, there is provided a method of preparing the composition comprising the composite material and the polymeric matrix as defined above.

In another aspect, there is provided an article containing the composition comprising the composite material and the polymeric matrix as defined above.

In another aspect, there is provided the use of the article as a packaging film for food packaging to improve the oxygen barrier.

### Definitions

The following words and terms used herein shall have the meaning indicated:

Unless stated otherwise, the term “mesoporous” used in the present disclosure is to be interpreted broadly to refer to a material containing pores with diameters between about 2 nm and about 50 nm, according to IUPAC nomenclature.

The term “microporous” as used herein refers to a material having pores with diameters smaller than 2 nm, according to IUPAC nomenclature.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a composite material comprising a mixture of a plurality of metal particles and a porous silica particle will now be disclosed.

The present disclosure provides said composite material comprising the mixture of the plurality of metal particles and the porous silica particle, wherein said plurality of metal particles is disposed within the pores of said porous silica particle.

The composite material of the present disclosure may be regarded as a nanostructured composite material. Said nanostructured composite material may contain a cavity. The nanostructured composite material may contain a cavity in the silica particle. Said cavity may be located in the center or the core of the silica particle. The cavity may be in contact with the pores of the silica particle such that there may be an exchange of fluid from the cavity through the pores to the external environment and vice versa.

The size of the cavity in the silica particle may be in the range of about 40 nm to about 80 nm, such as about 40 to about 50 nm, about 40 to about 60 nm, about 40 to about 70 nm, about 50 to about 60 nm, about 50 to about 70 nm, about 50 to about 80 nm, about 60 to about 70 nm, about 60 to about 80 nm or about 70 to about 80 nm. The size of the cavity in the silica particle is preferably about 60 nm. The size of the cavity as defined above may refer to the diameter of the cavity that is when the cross section of the cavity is substantially circle.

The metal particle of the composite material as defined herein may be a metal nanoparticle. The metal element of the metal particle may be a transition metal. Hence, it is to be understood that the metal particle of said composite material may be a transition metal nanoparticle. The metal element of the metal particle may be selected from Group 8 of the Periodic Table.

The metal element of the metal particle may be selected from the group consisting of iron (Fe), ruthenium (Ru), osmium (Os) and hassium (Hs). The metal element of the metal particle is preferably iron (Fe). Hence, the iron particle may be an iron nanoparticle. The metal particle above may be derived from a metal precursor, where said metal precursor may be in the form of a metal ion of a metal salt. It is to be appreciated that the metal elements in Group 8 of the Periodic Table may be found in multiple oxidation states. Therefore, when iron is the metal element, iron precursor may be found in the oxidation states of +2 or +3. In other words, the iron ion may have a charge of Fe²⁺ or Fe³⁺. Further, depending on its oxidation state, said iron ion may be reduced or oxidized. The iron ion may be reduced to iron nanoparticle i.e. zero oxidation state.

When iron is the metal element of said metal particle, the iron salt may be iron chloride, iron bromide, iron fluoride, iron iodide, iron sulfate, iron nitrate, iron oxalate, iron gluconate, iron acetylacetonate, iron fumarate or iron phosphate. It is to be understood that the iron in the above iron salt may be of +2 or +3 oxidation state. For example, when the iron salt is iron chloride, this chloride salt may be iron(II) chloride or iron(III) chloride.

The metal particle disposed within the pores of the silica particle may have a particle size in the range of about 1 nm to about 50 nm, such as from about 1 nm to about 10 nm, from about 1 nm to about 20 nm, from about 1 nm to about 30 nm, from about 1 nm to about 40 nm, from about 10 nm to about 20 nm, from about 10 nm to about 30 nm, from about 10 nm to about 40 nm, from about 10 nm to about 50 nm, from about 20 nm to about 30 nm, from about 20 nm to about 40 nm, from about 20 nm to about 50 nm, from about 30 nm to about 40 nm, from about 30 nm to about 50 nm or from about 40 nm to about 50 nm. The particle size of said metal particle is preferably in the range of about 6 nm to about 10 nm and more preferably in the range of about 1 nm to about 5 nm.

Where said metal particle is spherical, it is to be understood that the above particle size refers to the diameter of the metal particle. Where the metal particle is substantially spherical, the above particle size refers to the equivalent diameter of the metal particle.

The porous silica particle in the composite material as defined herein may be a porous silica nanoparticle. The porous silica nanoparticle may be mesoporous or microporous. The silica nanoparticle may have high surface area.

The silica particle may be in a spherical shape with a size in the range of about 20 nm to about 1000 nm, such as from about 20 nm to about 50 nm, from about 20 nm to about 80 nm, from about 20 nm to about 300 nm, from about 20 nm to about 500 nm, from about 20 nm to about 700 nm, from about 20 nm to about 900 nm, from about 50 nm to about 80 nm, from about 50 nm to about 300 nm, from about 50 nm to about 500 nm, from about 50 nm to about 700 nm, from about 50 nm to about 900 nm, from about 50 nm to about 1000 nm, from about 80 nm to about 300 nm, from about 80 nm to about 500 nm, from about 80 nm to about 700 nm, from about 80 nm to about 900 nm, from about 80 nm to about 1000 nm, from about 300 nm to about 500 nm, from about 300 nm to about 700 nm, from about 300 nm to about 900 nm, from about 300 nm to about 1000 nm, from about 500 nm to about 700 nm, from about 500 nm to about 900 nm, from about 500 nm to about 1000 nm, from about 700 nm to about 1000 nm or from about 900 nm to about 1000 nm. The size of said silica particle is preferably within the nanosize range (silica nanoparticle), more preferably about 100 nm.

The silica particle may be derived from a silicate precursor selected from the group consisting of tetraethyl orthosilicate (TEOS), tetramethyl orthosilicate, tetrapropyl orthosilicate tetrabutyl orthosilicate, tetraisopropyl orthosilicate and mixtures thereof. It is to be understood that the above silicate precursors are not limiting and therefore other suitable silicate precursors may be used.

The pores of said silica particle may also form channels within the silica particle. The diameter of the pore or channel within the silica particle may be in the range of about 1 nm to about 20 nm, such as from about 1 nm to about 5 nm, from about 1 nm to about 10 nm, from about 1 nm to about 15 nm, from about 5 nm to about 10 nm, from about 5 nm to about 15 nm, from about 5 nm to about 20 nm, from about 10 nm to about 15 nm, from about 10 nm to about 20 nm or from about 15 nm to about 20 nm. The diameter of the pore or channel is preferably in the range of about 5 to about 10 nm. Considering the size of the pore or channel within the silica particle, said channel within the silica particle or silica nanoparticle may therefore be termed as a nanosized channel.

The pores or the channels may extend from one surface of the silica particle to another surface of the silica particle or where there is a cavity present, from one surface of the silica particle to the cavity. The pores or the channels may form a tortuous path or may be a relatively straight path. The pores or the channels may be of a short distance and may be only within the interior of the silica particle or may extend from a surface into the interior of the silica particle.

The nanostructured composite material as defined herein may be an iron/silica hybrid nanoparticle. When said nanostructured composite material is an iron/silica hybrid nanoparticle, the iron ions (Fe²⁺ and/or Fe³⁺) may be adsorbed on the surface of the silica nanoparticles and also in the pores/channels of the silica particle. This adsorption may occur due to the electrostatic attraction between the iron ions and hydroxyl groups found on the surface of the silica nanoparticles. The content of iron particles in the Fe/silica hybrid nanoparticles may be dependent on the ratio of silica particles and iron salt during the incipient wetness impregnation step.

The content of metal in the hybrid metal/silica nanostructured composite material may be in the range of about 1 wt % to about 80 wt % based on the dry weight of silica particles such as from about 1 wt % to about 10 wt %, from about 1 wt % to about 20 wt %, from about 1 wt % to about 30 wt %, from about 1 wt % to about 40 wt %, from about 1 wt % to about 50 wt %, from about 1 wt % to about 60 wt %, from about 1 wt % to about 70 wt %, from about 10 wt % to about 20 wt %, from about 10 wt % to about 30 wt %, from about 10 wt % to about 40 wt %, from about 10 wt % to about 50 wt %, from about 10 wt % to about 60 wt %, from about 10 wt % to about 70 wt %, from about 10 to about 80 wt %, from about 20 wt % to about 40 wt %, from about 20 wt % to about 80 wt %, from about 30 wt % to about 60 wt %, from about 30 wt % to about 80 wt %, from about 40 wt % to about 60 wt %, from about 40 wt % to about 80 wt %, from about 50 wt % to about 80 wt %, from about 60 wt % to about 80 wt % or from about 70 wt % to about 80 wt % based on the dry weight of silica particles. Where the nanostructured composite material is the iron/silica hybrid nanoparticle, the content of iron in the hybrid Fe/Silica nanoparticles is from about 40 wt % to about 50 wt % based on the dry weight of silica particles.

Advantageously, the silica particle above may serve as a carrier for zero-valent metal particles. The nanosized channels in the porous silica particle may advantageously serve as a carrier and/or a protector for the growth of metal particles thereby enhancing the loading of such metal particles without aggregation. More advantageously, these channels may also prevent the nanosized metal particles from explosion and therefore the production of said nanostructured composite materials may be scaled up in industry production in a straightforward manner. The channels in the porous silica particle may also facilitate the diffusion of oxygen into the silica particle and thereby improving the contact between metal nanoparticles and oxygen molecules. Further, said channels may control the oxidation rate of the metal particles.

The nanostructured composite material having a relatively large cavity at the center may surprisingly further improve the contact of oxygen molecules and metal nanoparticles, resulting in a high oxygen scavenging capacity. The nanostructured composite material with a large cavity in the center is able to scavenge oxygen efficiently. The hollow in the nanostructured composite material can further facilitate the diffusion of oxygen in the particles and enhance the contact of metal nanoparticles and oxygen, leading to high oxygen scavenging performance.

The nanostructured composite material having a large cavity in the centre as defined above may have an oxygen scavenging performance in the range of about 190 cm³/g to about 210 cm³/g of metal such as from about 190 cm³/g to about 192 cm³/g, from about 190 cm³/g to about 194 cm³/g, from about 190 cm³/g to about 196 cm³/g, from about 190 cm³/g to about 198 cm³/g, from about 190 cm³/g to about 200 cm³/g, from about 190 cm³/g to about 202 cm³/g, from about 190 cm³/g to about 204 cm³/g, from about 190 cm³/g to about 206 cm³/g, from about 190 cm³/g to about 208 cm³/g, from about 192 cm³/g to about 210 cm³/g, from about 194 cm³/g to about 210 cm³/g, from about 196 cm³/g to about 210 cm³/g, from about 198 cm³/g to about 210 cm³/g, from about 200 cm³/g to about 210 cm³/g, from about 202 cm³/g to about 210 cm³/g, from about 204 cm³/g to about 210 cm³/g, from about 206 cm³/g to about 210 cm³/g or from about 208 cm³/g to about 210 cm³/g, of metal. The oxygen scavenging performance of said nanostructured composite material having a large cavity in the centre is preferably about 193 cm³/g of metal.

Exemplary, non-limiting embodiments of a method for preparing the composite material comprising a mixture of a plurality of metal particles and a porous silica particle as defined herein will now be disclosed.

The present disclosure provides a method for preparing a composite material comprising a mixture of a plurality of metal particles and a porous silica particle material for scavenging oxygen, comprising the steps of:

(i) adding said porous silica particle into a solution of metal ions under stirring to allow said metal ions to impregnate into the pores of said silica particle; and

(ii) reducing said metal ions in the presence of a reducing agent to form said metal particles, wherein said metal particles are disposed within the pores of said porous silica particle.

Advantageously, the method for preparing the composite material above involves simple preparation setup and hence when scaled-up, the production cost may be expected to be low. Considering the simplicity of the process above, the method may be scaled up in a straightforward manner.

Steps (i) and/or (ii) of the method of preparing the composite material above may be undertaken at a temperature ranging from about 20° C. to about 50° C. such as about 20° C. to about 30° C., about 20° C. to about 40° C., about 30° C. to about 40° C., about 30° C. to about 50° C. or about 40° C. to about 50° C. Hence, it is to be appreciated that steps (i) and/or (ii) above may be undertaken at room temperature.

In an embodiment, the method for preparing a composite material comprising the mixture of the plurality of metal particles and the porous silica particle material for scavenging oxygen may involve the steps of:

(a) dissolving a surfactant in water under basic pH condition and stirring the resulting solution at room temperature;

(b) adding a solution of silicate precursor into the solution under stirring at room temperature to thereby form a suspension of silica particle;

(c) immersing a purified and air-dried silica particle having a porous structure into a solution of metal ions to allow the metal ions to impregnate into the pores of said silica particle, wherein the resulting suspension is stirred for a period of time;

(d) adding a solution of a reducing agent into the suspension in step c) to form a solution of impregnated silica particle; and

(e) purifying and drying the solution of impregnated silica particle under an inert gas flow to thereby form said composite material.

For steps (a) and (b) of the above method, the room temperature may be in the range of about 20° C. to about 30° C. such as about 21° C., about 22° C., about 23° C., about 24° C. about 25° C., about 26° C., about 27° C., about 28° C. or about 29° C.

The method of preparing the composite material comprising a mixture of a plurality of metal particles and a silica particle for scavenging oxygen, may comprise the steps of:

(a) dissolving a surfactant in water, followed by mixing surfactant solution with a base (a basic solution) and a reactant, wherein the resulting solution is stirred at a suitable temperature;

(b) adding a solution of silicate precursor into the solution of step a), wherein the resulting mixture is stirred at a suitable temperature to thereby form a suspension of silica particle;

(c) immersing a purified and air-dried silica particle having a porous structure into a solution of metal ions to allow the metal ions to impregnate into the pores of the silica particle, wherein the resulting suspension is stirred for a period of time;

(d) adding a solution of a reducing agent into the suspension of step c) to form a solution of impregnated silica particle; and

(e) purifying and drying the solution of impregnated silica particle under inert gas flow to thereby form said composite material.

The “suitable temperature” referred to above may be regarded as a temperature at which the surfactant can be substantially dissolved in a solvent or a mixture of solvent. Hence, this suitable temperature may vary depending on the surfactant used. The suitable temperature referred to above may be in the range of about 20° C. to about 85° C., such as from about 20° C. to about 30° C., from about 20° C. to about 50° C., from about 30° C. to about 50° C., from about 30° C. to about 85° C. or from about 50° C. to about 85° C. Preferably, the suitable temperature is about 30° C.

Therefore, the composite material as defined herein may be advantageously prepared via one-step emulsion preparation method under mild condition and is therefore considered as a facile method.

The surfactant used in the above may be a cationic, anionic or zwitterionic surfactant. The cationic surfactant may be a quaternary ammonium salt. The quaternary ammonium salt may contain alkyl groups. The alkyl quaternary ammonium salt may be alkyltrimethylammonium salt selected from either cetyl trimethylammonium bromide (CTAB), cetyltrimethylammonium chloride (CTAC) or mixtures thereof. It is to be appreciated that the above examples are non-limiting and thus other suitable surfactant may be used. As aforementioned, the surfactant may be dissolved in water. However, it may also be dissolved in other suitable polar solvent such as short chain alcohol including ethanol, n-propanol, isopropanol, n-butanol or mixtures thereof.

The basic solution referred in the above method may be a solution with a pH value of 8 or above such as pH 8.5, 9, 9.5, 10, 10.5, 11, 11.5, 12, 12.5, 13 or 14. It is to be appreciated that the basic solution may comprise an inorganic base or an organic base. The basic solution may comprise the organic base dissolved in an aqueous solution. The aqueous solution may be water or deionized water. The aqueous solution is preferably water. The basic solution used in the above method may be ammonia solution. The concentration of the basic solution may be in the range of about 10 wt % to about 50 wt % such as from about 10 wt % to about 20 wt %, from about 10 wt % to about 30 wt %, from about 10 wt % to about 40 wt %, from about 20 wt % to about 30 wt %, from about 20 wt % to about 50 wt %, from about 30 wt % to about 50 wt % or from about 40 wt % to about 50 wt %. Preferably, the concentration of the basic solution is about 30 wt %.

The solution of silicate precursor may comprise the silicate precursor dissolved in an organic solvent. The organic solvent may be a nonpolar solvent or a polar solvent. Non-limiting examples of the nonpolar organic solvent may include pentane, hexane, tetrahydrofuran (THF), cyclohexane, benzene or mixtures thereof. Non-limiting examples of the polar organic solvent may include methanol, ethanol, acetonitrile, dimethyl sulfoxide (DMSO), N,N-dimethyl formamide (DMF) or mixtures thereof. The organic solvent used is preferably the nonpolar solvent, more preferably hexane.

The aqueous solution above when mixed with said nonpolar solvent may form an emulsion. Said emulsion system may comprise immiscible solvents, that is, a system at least two phases that do not substantially mix with each other is formed. The immiscible solvents having two separate phases above may comprise a nonpolar solvent and a polar solvent.

The resulting solution or mixture of step (i), (a) and/or (b) may be stirred for about 10 minutes to about 14 hours, such as about 10 minutes to about 30 minutes, 10 minutes to about one hour, one hour to about 5 hours, about one hour to about 10 hours, about 5 hours to about 10 hours, about 5 hours to about 14 hours, about 10 hours to about 11 hours, about 10 hours to about 12 hours, about 10 hours to about 13 hours, about 10 hours to about 14 hours, about 11 to about 14 hours, about 12 to about 14 hours or about 13 to about 14 hours.

The stirring may be undertaken under a constant or variable stirring speed in the range of about 100 rpm to about 10000 rpm such as about 200 rpm, about 500 rpm, about 1000 rpm, about 3000 rpm, about 6000 rpm or about 9000 rpm. The constant stirring speed is preferred at 500 rpm for step a) and 9000 rpm for step b). It is to be appreciated that the stirring speed used in step (b) is higher than that in step a) as a suspension would have been formed in step (b). Further, the duration of mixing or stirring process in step a) and/or b) may depend on the stirring speed used. Preferably, step a) is stirred at 500 rpm for about 30 minutes and step (b) is stirred at 9000 rpm for about 12 hours.

Following step (b), the resulting silica particle may be purified for example via centrifugation followed by washing the purified silica particle. This purification step may be repeated 1, 2, 3, 4, 5, 6, 7, 8, 9 or 10 time(s). Such purification step may involve the addition of an acidic solution into the suspension containing the silica particle as defined above, washing and/or re-dispersing of the silica particle in an organic solvent.

The acidic solution may comprise an acid or a mixture of two or more acids dissolved in a solvent. It is understood that said acidic solution has a pH less than 7, such as 1, 2, 3, 4, 5, or 6. The solvent used may be an organic solvent or an aqueous solvent. The acid may be inorganic or organic acid, strong or weak acid. Non-limiting examples of such acid may include hydrochloric acid, hydrobromic acid, sulfuric acid, nitric acid, phosphoric acid and acetic acid. The acidic solution is preferably hydrochloric acid in water. The organic solvent used to wash and/or re-disperse the silica particle is as defined above.

When centrifugation is used, the rotational speed of the centrifugation may be in the same range of the stirring step above i.e. from about 100 rpm to about 10000 rpm for a period of time similar as the time required for stirring above i.e. from about 10 minutes to about 14 hours. The temperature in the purification step may be in the range of about 20° C. to about 70° C., such as about 30° C., about 40° C., about 50° C. or about 60° C. Other suitable temperature falling within the range above may be used.

In an exemplary embodiment, the silica particle added in step (i) or that obtained in step (b) may be purified via centrifugation at about 9000 rpm for about 10 minutes and washed with ethanol twice. The silica particle may be re-dispersed in ethanol solution with 1 M hydrochloric acid. The resulting suspension may be stirred at about 500 rpm at about 60° C. for about 5 hours. Finally, the suspension is purified via centrifugation at about 9000 rpm for about 10 minutes to remove excess of surfactant molecules in the silica particles. This final step may be repeated prior to air drying and vacuum drying the purified silica particles.

Advantageously, the purified silica particles may be porous silica nanoparticles. Such porous silica nanoparticles may be easily dispersible in a solution for example an aqueous solution.

In step (i) of the above method or step (c) of the specific embodiment of the method of preparing the composite, the solution of metal ions may be a solution of iron ions. The iron ion may be derived from the iron salt as defined above. The iron salt may be dissolved in aqueous solution. The aqueous solution may be water or deionised water.

For clarity, when iron is the metal element of said metal ions, the iron ions may be derived from the iron salt selected from the group consisting of iron chloride, iron bromide, iron fluoride, iron iodide, iron sulfate, iron nitrate, iron oxalate, iron gluconate, iron acetylacetonate, iron fumarate and iron phosphate. It is to be understood that the iron in the above iron salt may be in the oxidation state of +2 or +3. For example, when the iron salt is iron chloride, this chloride salt may be iron(II) chloride or iron(III) chloride.

For step (c) of the specific embodiment of the method of preparing the composite material as described above, the silica suspension may be stirred for about 10 hours to about 14 hours such as about 10 hours to about 11 hours, about 10 hours to about 12 hours, about 10 hours to about 13 hours, about 11 hours to about 14 hours, about 12 hours to about 14 hours or about 13 hours to about 14 hours. Preferably, the resulting mixture in step c) is stirred for about 12 hours to allow the complete or substantially complete adsorption of metal ions in the channels of the silica particle.

In step (ii) of the above method or step (d) of the specific embodiment of the method of preparing the composite material as described herein, the solution of the reducing agent may be added to the resulting suspension slowly or dropwise. The reducing agent that can be used in the above method may be selected from the group consisting of sodium borohydride, lithium aluminium hydride, diisobutyl aluminium hydride (DIBAL-H) and sodium cyanoborohydride.

Following the above steps, the resulting composite material may be produced having a particle size in the range of about 10 nm to about 300 nm, such as about 10 nm to about 20 nm, about 10 nm to about 50 nm, about 10 nm to about 100 nm, about 10 nm to about 150 nm, about 10 nm to about 200 nm, about 10 nm to about 250 nm, about 20 nm to about 50 nm, about 20 nm to about 100 nm, about 20 nm to about 150 nm, about 20 nm to about 200 nm, about 20 nm to about 250 nm, about 20 nm to about 300 nm, about 50 nm to about 100 nm, about 50 nm to about 150 nm, about 50 nm to about 200 nm, about 50 nm to about 250 nm, about 50 nm to about 300 nm, about 100 nm to about 150 nm, about 100 nm to about 200 nm, about 100 nm to about 250 nm, about 100 nm to about 300 nm, about 150 nm to about 200 nm, about 150 nm to about 250 nm, about 150 nm to about 300 nm, about 200 nm to about 250 nm, about 200 nm to about 300 nm or about 250 nm to about 300 nm. Preferably, the resulting composite material has a particle size of about 20 nm to about 200 nm.

The size of the channel formed within the resulting composite material may be in the range of about 1 nm to about 10 nm such about 1 nm to about 2 nm, about 1 nm to about 3 nm, about 1 nm to about 4 nm, about 1 nm to about 5 nm, about 1 nm to about 6 nm, about 1 nm to about 7 nm, about 1 nm to about 8 nm, about 1 nm to about 9 nm, about 2 nm to about 10 nm, about 3 nm to about 10 nm, about 4 nm to about 10 nm, about 5 nm to about 10 nm, about 6 nm to about 10 nm, about 7 nm to about 10 nm, about 8 nm to about 10 nm or about 9 nm to about 10 nm. The size of said channel is preferably about 5 nm.

For steps (a) and/or (b) of the specific embodiment of the method for preparing the composite material, when the stirring is undertaken at a higher temperature of about 30° C., a large cavity may be formed in the silica particle. The size of such large cavity may be in the range of about 40 nm to about 80 nm such as about 40 nm to about 50 nm, about 40 nm to about 60 nm, about 40 nm to about 70 nm, about 50 nm to about 80 nm, about 60 nm to about 80 nm or about 70 nm to about 80 nm. Preferably, the size of said large cavity is about 60 nm.

Accordingly, the composite material obtained when the stirring is undertaken at a higher temperature of about 30° C. in steps (a) and/or (b) may have a larger particle size in the range of about 60 nm to about 100 nm such as about 60 nm to about 70 nm, about 60 nm to about 80 nm, about 60 nm to about 90 nm, about 70 nm to about 100 nm, about 80 nm to about 100 nm or about 90 nm to about 100 nm. The particle size of the composite material having the large cavite as described above is preferably about 80 nm.

The reactant of step (a) as aforementioned may be a chemical compound that is capable of generating the large hollow cavity in the silica particle. Such reactant may be an alkyl ester. Said alkyl ester may comprise of C₁-C₆ alkyl groups such as methyl, ethyl, propyl or isopropyl. The alkyl ester used as the reactant in step (a) is preferably ethyl ester.

Advantageously, the size and structure of the porous silica particle may be easily tuned by changing the ratio of precursors. The size of the channel in the composite material may be uniform along the individual channel of the mesoporous silica particle.

Exemplary, non-limiting embodiments of a composition comprising the composite material as defined herein and a porous silica particle will now be disclosed.

The present disclosure further provides a composition comprising:

a) a composite material comprising a mixture of a plurality of metal particles and a porous silica particle material, wherein said plurality of metal particles is disposed within the pores of said porous silica particle; and
b) a polymeric matrix.

The above composite material may be essentially the composite material as described in the previous section and those described in the examples. Hence, it is to be appreciated that some (if not all) of the characteristics or properties of the aforementioned composite material may likewise be applicable here i.e. to describe component a) of the above composition.

Non-limiting examples of said polymeric matrix may include montmorillonite, bentonite, laponite, kaolinite, saponite, vermiculite or mixtures thereof. It is to be understood that other suitable polymeric matrix may be used. Further, said polymeric matrix may be clay selected from the group consisting of natural clay, synthetic clay and silane(s) modified clay. Said polymeric matrix i.e. component b) may be added to the composite material in a small amount to form the above composition.

Exemplary, non-limiting embodiments of a method for preparing a composition comprising a composite material and a polymeric matrix as described above will now be disclosed.

Additionally, the present invention also provides a method of preparing a composition comprising:

a) a composite material comprising a mixture of a plurality of metal particles and a porous silica particle material; and

b) a polymeric matrix,

wherein said plurality of metal particles is disposed within the pores of said porous silica particle, and

wherein said method comprises the steps of dispersing said composite material in a solution of alkyl alcohol and adding an amount of polymeric matrix.

The method of preparing the composition may comprise the steps of dispersing the composite material in a solution of alkyl alcohol and adding a small amount of polymeric matrix. The dispersion of composite material in the solution of alkyl alcohol may be obtained by stirring at high speed or homogenization for a period of time under inert gas flow.

Said alkyl alcohol may be made up of C₁-C₆ alkyl groups or C₆-C₁₂ alkyl groups. The solution of alkyl alcohol may be ethylene vinyl alcohol (EVOH) or polyvinyl alcohol (PVOH). The inert gas in the inert gas flow may be nitrogen or argon gas. The period of time required for stirring may be in the range of about one minute to about 5 minutes such as about one minute to about 2 minutes, about one minute to about 3 minutes, about one minute to about 4 minutes, about 2 minutes to about 5 minutes, about 3 minutes to about 5 minutes or about 4 minutes to about 5 minutes. The period of time above is preferably about one minute.

In order to obtain a homogeneous dispersion of said composition, a high stirring speed may be required when the polymeric matrix is added into the suspension of composite material i.e. component a). Such high stirring speed may be in the range of about 5000 rpm to about 15000 rpm, such as about 8000 rpm, about 9000 rpm, about 10000 rpm, about 12000 rpm or about 14000 rpm.

The resulting suspension composition may be applied onto a polymeric substrate. Non-limiting examples of the polymer of said polymeric substrate may include polyethylene terephthalate (PET), polypropylene (PP) or polyethylene (PE). It is to be appreciated that the polymer may be in the form of homopolymer, co-polymer or blends thereof.

Exemplary, non-limiting embodiments of an article containing a composition comprising a composite material and a polymeric matrix will now be disclosed.

The present disclosure further provides an article containing a composition comprising a composite material and a polymeric matrix as described above. Specifically, the present disclosure provides an article containing a composition comprising a composite material and a polymeric matrix as described above, wherein said composite material comprises a mixture of the plurality of metal particles and the porous silica particle material as described above.

The composite material may be substantially similar to that as described in the previous section and those described in the examples. Hence, it is to be appreciated that some (if not all) of the characteristics or properties of the aforementioned composite material may likewise be applicable here.

The article containing the composition may be in the form of a transparent coated film. The article may be a paper or a cellulose material.

Exemplary, non-limiting embodiments of the use of an article as defined herein for a packaging film will now be disclosed.

The present disclosure further provides the use of an article as defined herein for a packaging film in the food packaging having improved oxygen barrier.

In summary, the composite material of the present disclosure and the method of preparing the same have many benefits at least from the following perspectives and hence solves the technical problem associated with iron particles as the oxygen scavenger:
Silica particle of the composite material can serve as a carrier for the plurality of metal particles.
Nanosized channels formed in the porous silica particle are beneficial as they can serve as a carrier and protector for the growth of metal particles and to thereby enhancing the loading of the metal particles without aggregation.
The channels formed can prevent the nanosized metal particles from explosion. Therefore, the resulting nanostructured composite materials are easy to be adopted in industry production.
The channels formed within the porous silica particle can facilitate the diffusion of oxygen into the silica particle and to thereby improving the contact between metal nanoparticles and oxygen molecules.
The channels control the oxidation rate of metal particles.
The composite material as described herein can be obtained in a facile method via a one-step emulsion preparation method under mild condition. Hence, such process requires a simple production setup and thus may be regarded as low cost process.
The size and structure of the porous silica particle can be easily tuned by varying the ratio of precursors. The size of the channel in the composite material is substantially uniform along the individual channel of the mesoporous silica particle.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows two methods for preparing the composite material Fe/S1 and Fe/S2, described in Examples 1 and 2, respectively.

FIG. 2 is a number of transmission electron microscope (TEM) images of the mesoporous silica nanoparticles and of the Fe/silica nanoparticles (Fe/S1) synthesized from mesoporous silica nanoparticles as described in Example 1. FIG. 2A shows TEM image of mesoporous silica nanoparticles at low magnification (with a scale bar of 100 nm); FIG. 2B shows TEM image of mesoporous silica nanoparticles at high magnification (with a scale bar of 20 nm); FIG. 2C depicts TEM image of Fe/S1 nanoparticles at low magnification (with a scale bar of 100 nm); FIG. 2D describes TEM image of Fe/S1 nanoparticles at high magnification (with a scale bar of 20 nm).

FIG. 3 is a number of transmission electron microscope (TEM) images of the mesoporous silica nanoparticles and of the Fe/silica nanoparticles with large cavity (Fe/S2) synthesized from mesoporous silica nanoparticles as described in Example 2. FIG. 3A shows TEM image of mesoporous silica nanoparticles at low magnification (with a scale bar of 100 nm); FIG. 3B shows TEM image of mesoporous silica nanoparticles at high magnification (with a scale bar of 50 nm); FIG. 3C depicts TEM image of Fe/S2 nanoparticles at low magnification (with a scale bar of 100 nm); FIG. 3D describes TEM image of Fe/S2 nanoparticles at high magnification (with a scale bar of 20 nm).

FIG. 4 is a graph obtained from an X-ray diffraction (XRD) analysis of the Fe/silica nanoparticles with large cavity (Fe/S2) obtained in Example 2.

FIG. 5 is a number of graphs summarizing the results obtained from the oxygen scavenging test as described in Example 3.

FIG. 6 is a photograph of a transparent Fe/S2 nanoparticles coating on polyethylene terephthalate (PET) film as described in Example 4.

### DETAILED DESCRIPTION OF DRAWINGS

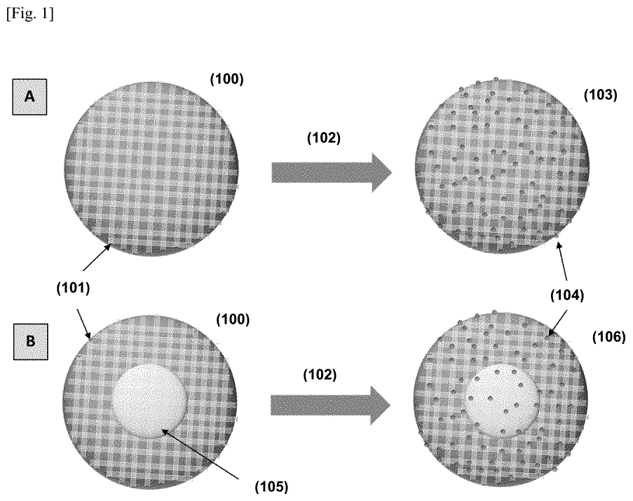

Referring to FIG. 1, this figure describes two methods for preparing the composite material of the present disclosure. FIG. 1A depicts a method for synthesizing the composite material Fe/S1 as described in Example 1. In FIG. 1A, it can be seen that nanosized channels (101) are found within the mesoporous silica particle (100). After addition of the iron solution (102), composite material Fe/S1 (103) is formed having iron nanoparticles (104) adsorbed in said nanosized channels (101) of mesoporous silica particle (100).

On the other hand, FIG. 1B depicts a method for synthesizing the composite material Fe/S2 as described in Example 2. In FIG. 1B, it can be observed that nanosized channels (101) are found within the mesoporous silica particle (100) with a large cavity (105). After addition of the iron solution (102) via wet impregnation process, composite material Fe/S2 (106) is formed having iron nanoparticles (104) adsorbed in said nanosized channels (101) of mesoporous silica particle (100) having a large cavity (105). The iron nanoparticles (104) may be also adsorbed and attached to the inner walls in said large cavity (105).

### EXAMPLES

Non-limiting examples of the invention and a comparative example will be further described in greater detail by reference to specific Examples, which should not be construed as in any way limiting the scope of the invention.

### Example 1: Preparation of Porous Fe/Silica from Mesoporous Silica Nanoparticles (Fe/S1)

Schematic diagram of the mesoporous silica nanoparticles and composite material Fe/S1 is depicted in FIG. 1A.

a) Preparation of Mesoporous Silica Nanoparticles

2 g of cetyl trimethylammonium bromide (CTAB) (98%, purchased from Alfa Aesar of Lancashire of the United Kingdom) was dissolved in water and mixed with 10 mL of ammonia solution (28-30%, purchased from Honeywell of New Jersey of the United States of America). The resulting mixture (i.e. a first mixture) was stirred at 500 rpm under room temperature for about 30 minutes. With vigorous stirring, 40 mL of hexane solution of tetraethyl orthosilicate (TEOS, purchased from Sigma Aldrich of St. Louis, Mo. of the United States of America) was added dropwise into the first mixture for about 30 minutes. Upon completion of the addition of TEOS solution, a second mixture was obtained and further stirred for about 12 hours under room temperature to form mesoporous silica nanoparticles. The resulting mesoporous silica nanoparticles were recovered via centrifugation at 9000 rpm for about 10 minutes and washed with ethanol twice.

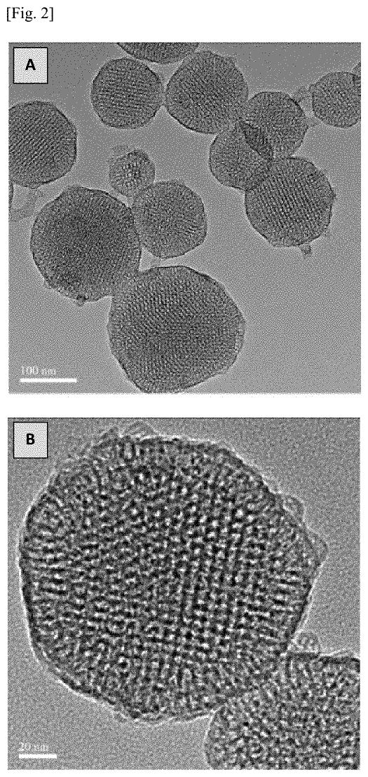

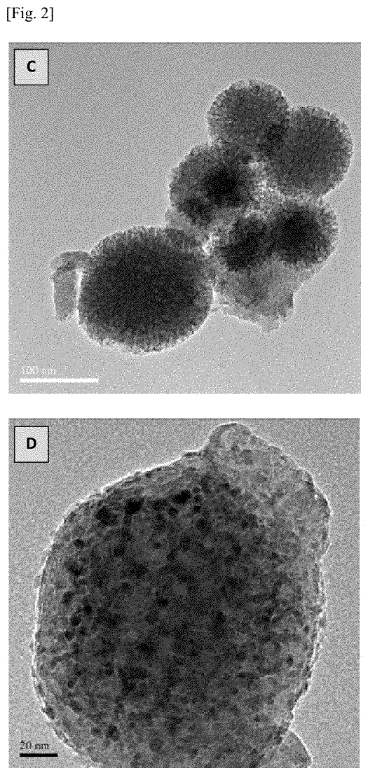

The purified nanoparticles were re-dispersed in ethanol solution (purchased from Green Tropic Products Pte Ltd of Singapore) with 1 M hydrochloric acid (purchased from Sigma Aldrich of St. Louis, Mo. of the United States of America). The resulting suspension was stirred at 500 rpm at about 60° C. for approximately 5 hours and the nanoparticles were then purified using centrifugation at 900 rpm for about 10 minutes to remove the excess of CTAB molecules in the silica particles. This removal step was repeated to ensure that most of the CTAB molecules were eliminated from the silica nanoparticles. Following this, the nanoparticles were air dried and vacuum dried at room temperature. The transmission electron microscope (TEM) images of the mesoporous silica nanoparticles using low and high magnification are depicted in FIGS. 2A and 2B, respectively.

b) Preparation of Fe/S1

2 g of mesoporous silica nanoparticles obtained in step a) were dispersed in 50 mL of water to form a first suspension. Following this, 5 mL of a solution of ferric chloride (0.5 g, purchased from Sigma Aldrich of St. Louis, Mo. of the United States of America) was added into the first suspension dropwise. The resulting suspension was stirred for about 12 hours to ensure the adsorption of Fe³⁺ ions in the channels of mesoporous silica. With vigorous stirring, 4 mL solution of sodium borohydride (0.35 g, purchased from Honeywell Fluka of New Jersey of the United States of America) was added into silica suspension dropwise. The final product was purified via centrifugation followed by drying in oven or furnace with inert gas flow. The TEM images of the Fe/S1 nanoparticles using low and high magnification are depicted in FIGS. 2C and 2D.

As shown in FIG. 2, transmission electron microscope (TEM) images revealed that the synthesized porous silica nanoparticles obtained via emulsion reaction method have the particle size in a range from about 20 nm to about 200 nm. The size and structure of the porous silica nanoparticles may be easily tuned by changing the ratio of precursors.

The mesoporous silica nanoparticles are embedded with ordered nanoscale empty channels after the surfactant CTAB was removed. Upon analysis of FIG. 2B, the size of such empty channels is estimated to be about 5 nm and appears to be fairly uniform along individual channel in the mesoporous silica nanoparticles. The TEM image in FIG. 2D revealed that the Fe nanoparticles having a size of about 5 nm are uniformly distributed in silica nanoparticles. The actual content of iron in the Fe/Si was determined to be about 30 wt % by inductively coupled mass spectrometry (ICP-MS).

### Example 2: Preparation of Porous Fe/Silica from Mesoporous Silica Nanoparticles with Large Cavity (Fe/S2)

Schematic diagram of the mesoporous silica nanoparticles and composite material with large cavity Fe/S2 is depicted in FIG. 1B.

a) Preparation of Mesoporous Silica Nanoparticles

0.6 g of CTAB (98%, purchased from Alfa Aesar of Lancashire of the United Kingdom) was dissolved in 70 mL of water and mixed with 0.6 mL of ammonia solution (28-30%, purchased from Honeywell of New Jersey of the United States of America), and 20 mL of anhydrous ethyl ester (purchased from TEDIA of Ohio of the United States of America). The resulting solution was stirred at 500 rpm at 30° C. for about 30 minutes. With vigorous stirring, 3.5 mL of TEOS was added dropwise into the solution for about 10 minutes. Upon complete addition of TEOS, the mixture was further stirred for about 12 hours at 30° C. to produce the mesoporous silica nanoparticles. The products were purified via centrifugation at 9000 rpm for 10 minutes and washed two times with ethanol.

The silica nanoparticles were re-dispersed in ethanol solution with 1 M hydrochloric acid. The resulting suspension was stirred at 500 rpm for 5 hours at about 60° C. and was then purified by centrifugation at 9000 rpm for about 10 minutes to remove excess CTAB molecules in the silica particles. The step of removing CTAB was repeated to ensure that most of the CTAB was eliminated from the silica nanoparticles. Finally, the particles were air dried followed by vacuum drying at room temperature.

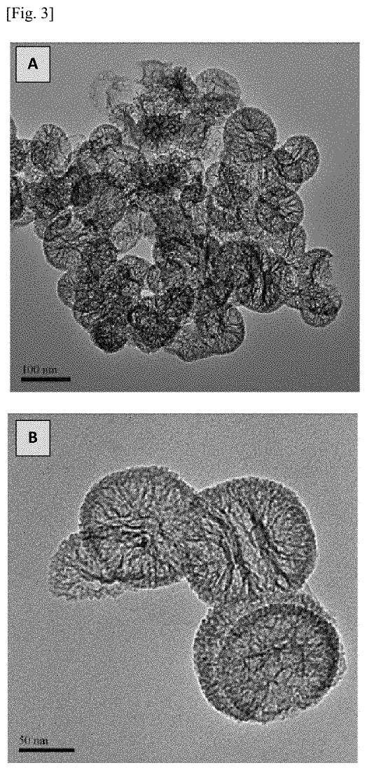

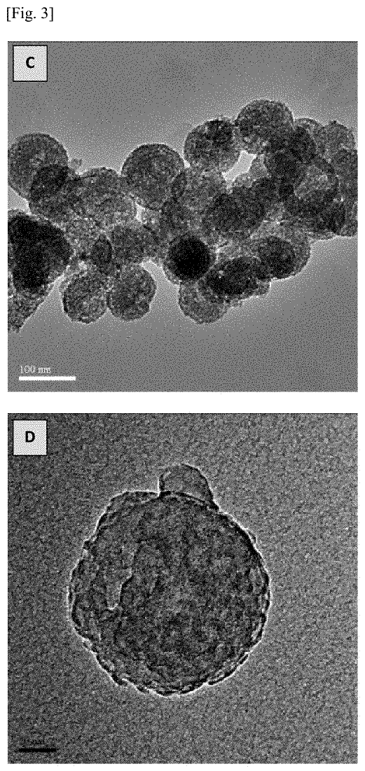

The TEM images of the mesoporous silica nanoparticles with large cavity using low and high magnification are depicted in FIGS. 3A and 3B.

b) Preparation of Fe/S2

1 g of mesoporous silica nanoparticles was dispersed in 25 mL of water to form a suspension. A solution of ferric chloride (0.25 g, 2.5 mL) was added dropwise into the suspension to form a second suspension. The resulting suspension was stirred for about 12 hours to ensure the adsorption of Fe ions in the channels of the mesoporous silica.

With vigorous stirring, 2 mL of sodium borohydride (0.2 g) solution was added dropwise into the suspension. The final product was purified via centrifugation and dried in a furnace with inert gas flow. The TEM images of the Fe/silica nanoparticles synthesized from mesoporous silica nanoparticles with large cavity using low and high magnification are shown in FIGS. 3C and 3D.

As can be seen from FIG. 3, mesoporous silica nanoparticles with a size of approximately 80 nm were observed. In each mesoporous silica nanoparticle, a relatively large cavity was formed with a size of about 60 nm.

After the growth of Fe nanoparticles, there was no significant change in the shape of silica nanoparticles. Fe nanoparticles with a size of less than 2 nm were uniformly distributed in silica nanoparticles.

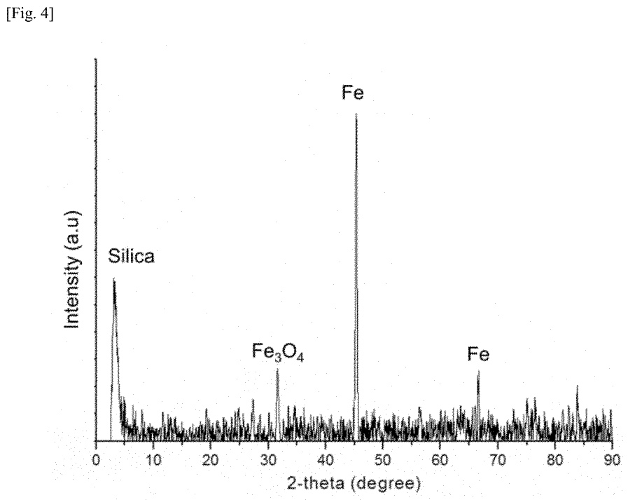

X-ray diffraction (XRD) analysis shown in FIG. 4 revealed that most of the iron particles in the mesoporous silica nanoparticles are of zero valent and only minor amount of iron oxide was present. The actual content of Fe in the Fe/S2 determined by ICP-MS was found to be about 34.7 wt %.

### Example 3: Oxygen Scavenging Test of Fe/S1 and Fe/S2

To evaluate the oxygen scavenging performance of sample Fe/S1 and Fe/S2, 0.1 g of each sample with 7.5 wt % of NaCl was placed into a 25-mL glass conical flask. A vial containing 1 mL of water was placed inside the flask to adjust the room humidity (RH) to 100%. The flask was then sealed with a glass-tight rubber septum stopper and placed at room temperature for the duration of the oxygen scavenging experiment. As can be seen from Table 1, both Fe/S1 and Fe/S2 are capable of removing most of the oxygen from the model packaging after three days. Fe/S2 displayed higher scavenging capacity (193 cm3 vs. 177 cm3) and faster scavenging rate than Fe/S1.

TABLE 1
Oxygen scavenging performance of Fe/S1, Fe/S2 and Fe/C

| | Oxygen Capacity | Oxygen Capacity | Oxygen Capacity |
|---|---|---|---|
| Time | of Fe/S1 | of Fe/S2 | of Fe/C with 40 wt % Fe |
| (hours) | (cm³/g Fe) | (cm³/g Fe) | (cm³/g Fe) |
| 0 | 0 | 0 | 0 |
| 2 | 6.7 | 11.5 | 16.6 |
| 4 | 28.3 | 47.6 | 40.5 |
| 6 | 63.3 | 82.1 | 51.2 |
| 8 | 81.7 | 125.4 | 82.1 |
| 24 | 175.0 | 193.5 | 219.4 |
| 48 | 177.0 | 193.5 | 230.2 |
| 72 | 177.0 | 193.1 | 229.5 |

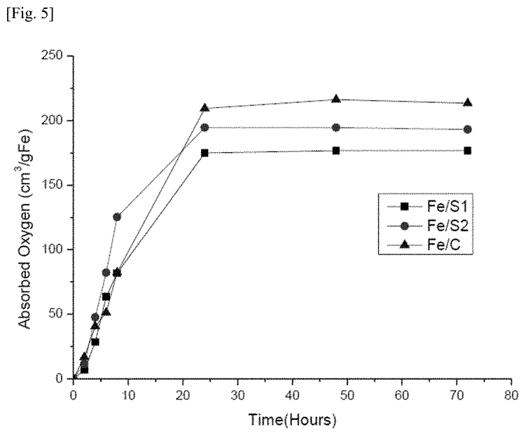

As can be observed in FIG. 5, the oxygen scavenging performance of Fe/S2 is comparable to Fe/C nanocomposites (with 40 wt % Fe). It is noteworthy that the preparation of the Fe/Si oxygen scavenger in the present invention is more cost-effective than that of Fe/C nanocomposites.

### Example 4: Preparation of Polymer Composites Film with Fe/Si Nanoparticles

Fe/S2 was dispersed in EVOH solution by adding small amount of clay (about 5 wt % based on the weight of Fe/S2). The dispersion of Fe/S2 in EVOH solution was achieved by homogenization at 10000 rpm for one minute, flushed with Argon gas. The suspension was then coated on PET film with coating thickness of about 20 μm. The coated film was then dried in vacuum oven at 60° C.

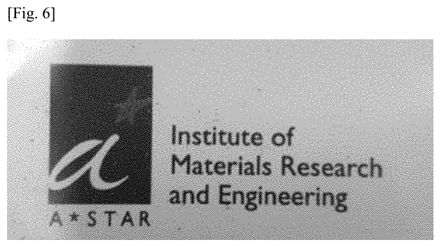

As can be seen from FIG. 6, transparent coated film was obtained with the content of Fe/S2 up to 20 wt %. These transparent films with Fe/Silica oxygen scavengers could be used as oxygen scavenging packaging films to prolong the shelf life of food and incorporated with barrier polymer films to further improve the oxygen barrier.

### INDUSTRIAL APPLICABILITY

As can be seen from the detailed description and examples provided, the composite material of the present disclosure exhibits promising oxygen scavenging performance and therefore may be potentially used for the food, beverage and pharmaceutical applications. Specifically, the composite material of the present disclosure may be used for food, beverage or pharmaceutical packaging.

The composite material of the present disclosure such as Fe/silica nanoparticles may be directly used as sachets to scavenge oxygen. Further, Fe/silica nanoparticles may also be integrated into a polymeric matrix to form coated or laminated films. Alternatively, Fe/silica nanoparticles may be integrated in extruded/blown polymer films or bottles.

In addition to the above, the composite material may also be used as a metallic based oxygen scavenger that is non-detectable by industrial metal detector commonly used in the food and pharmaceutical processing and packaging industries. The composite material may also be used in biological application including bio-imaging and drug delivery.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A composite material comprising a mixture of a plurality of metal particles and a porous silica particle, wherein said plurality of metal particles is disposed within pores of said porous silica particle, wherein said composite material is a nanostructured composite material having a cavity in a range of 40 nm to 80 nm.

2. The composite material according to claim 1, wherein said porous silica particle comprises a nanosized channel.

3. The composite material according to claim 1, wherein said metal particle is a metal nanoparticle.

4. The composite material according to claim 3, wherein the metal of said metal nanoparticle is selected from Group 8 of the Periodic Table.

5. The composite material according to claim 1, wherein the particle size of the metal particle is in the range of 1 nm to 50 nm.

6. The composite material according to claim 1, wherein said porous silica particle is a porous silica nanoparticle.

7. The composite material according to claim 6, wherein a particle size of said porous silica nanoparticle is in a range of 20 nm to 1000 nm.

8. The composite material according to claim 6, wherein said porous silica nanoparticle is selected from the group consisting of tetraethyl orthosilicate (TEOS), tetramethyl orthosilicate, tetrapropyl orthosilicate tetrabutyl orthosilicate, and tetraisopropyl orthosilicate.

9. The composite material according to claim 1, wherein said nanostructured composite material having a cavity has an oxygen scavenging performance in a range of 190 cm³/g to 210 cm³/g of metal.

10. A method of preparing a composite material comprising a mixture of a plurality of metal particles and a porous silica particle material, comprising the steps of:
a) dissolving a surfactant in water, followed by mixing surfactant solution with a base and a reactant, wherein a resulting solution is stirred at a suitable temperature;
b) adding a solution of silicate precursor into the solution of step a), wherein a resulting mixture is stirred at a suitable temperature to thereby form a suspension of silica particle;
c) immersing a purified and air-dried silica particle having a porous structure into a solution of metal ions to allow the metal ions to impregnate into pores of the silica particle, wherein a resulting suspension is stirred for a period of time;
d) adding a solution of a reducing agent into the suspension of step c) to form a solution of impregnated silica particle; and
e) purifying and drying the solution of impregnated silica particle under inert gas flow to thereby form said composite material;
wherein said composite material is a nanostructured composite material having a cavity in a range of 40 nm to 80 nm.

11. The method according to claim 10, wherein said metal ions are iron ions derived from an iron salt selected from the group consisting of iron chloride, iron bromide, iron fluoride, iron iodide, iron sulfate, iron nitrate, iron oxalate, iron gluconate, iron acetylacetonate, iron fumarate, and iron phosphate.

12. The method according to claim 10, wherein said reducing agent is selected from the group consisting of sodium borohydride, lithium aluminum hydride, diisobutylaluminium hydride (DIBAL-H), and sodium cyanoborohydride.

13. The method according to claim 10, wherein said reactant is an alkyl ester.

14. A composition comprising:
a) a composite material comprising a mixture of a plurality of metal particles and a porous silica particle material, wherein said plurality of metal particles is disposed within pores of said porous silica particle, and wherein said composite material is a nanostructured composite material having a cavity in the range of 40 nm to 80 nm; and
b) a polymeric matrix.

15. The composition according to claim 14, wherein said polymeric matrix is selected from the group consisting of montmorillonite, bentonite, laponite, kaolinite, saponite, vermiculite, and mixtures thereof.

16. A method of preparing a composition comprising:
a) a composite material comprising a mixture of a plurality of metal particles and a porous silica particle material; and
b) a polymeric matrix,
wherein said plurality of metal particles is disposed within pores of said porous silica particle, wherein said composite material is a nanostructured composite material having a cavity in the range of 40 nm to 80 nm, and
wherein said method comprises the steps of dispersing said composite material in a solution of alkyl alcohol and adding an amount of polymeric matrix.

17. An article containing a composition comprising a composite material and a polymeric matrix according to claim 14.

18. The article according to claim 17, wherein said article is a transparent coated film.

19. (canceled)
